(19) United States
(12) Patent Application Publication
(10) Pub. No.: US 2021/0357749 A1
(43) Pub. Date: Nov. 18, 2021

(54) METHOD FOR PARTIAL TRAINING OF ARTIFICIAL INTELLIGENCE AND APPARATUS FOR THE SAME

(71) Applicant: ELECTRONICS AND TELECOMMUNICATIONS RESEARCH INSTITUTE, Daejeon (KR)

(72) Inventor: Young-Joo KIM, Daejeon (KR)

(21) Appl. No.: 17/104,932

(22) Filed: Nov. 25, 2020

(30) Foreign Application Priority Data
May 15, 2020 (KR) 10-2020-0058344

(51) Int. Cl. G06N 3/08; G06N 3/04

(52) U.S. Cl. CPC G06N 3/08; G06N 3/04

(57) ABSTRACT

The disclosed embodiment relates generally to technology for training AI for recognizing objects, and more particularly to a method for partial training of AI. The method includes generating preprocessed input data by preprocessing input data, generating an inference result by inputting the preprocessed input data to the existing learning model of an inferrer, determining whether partial training is required based on the inference result, generating a partial-training dataset by combining first data, corresponding to the existing learning model, with second data, corresponding to the preprocessed input data, when it is determined that partial training is required, and performing partial training by inputting the partial-training dataset to a learner.

### CROSS REFERENCE TO RELATED APPLICATION

This application claims the benefit of Korean Patent Application No. 10-2020-0058344, filed May 15, 2020, which is hereby incorporated by reference in its entirety into this application.

### BACKGROUND OF THE INVENTION

### 1. Technical Field

The present invention relates to technology for training Artificial Intelligence (AI) for recognizing objects.

### 2. Description of the Related Art

These days, AI technology based on training and inference technology are diversely applied in various industrial technology fields. Particularly, technology for recognizing objects using AI is widely used for technology for monitoring for abnormal situations in real time, and the like.

Generally, technology for recognizing objects using deep-learning technology of AI is configured to generate a learning model by learning a large amount of previously prepared data in a high-performance computer and to recognize various kinds of objects after loading the learning model into a recognizer. However, the recognizer generated in this way may have objects that cannot be recognized thereby when the use environment and conditions are changed, and may exhibit a low recognition rate for certain objects. Accordingly, in order to solve these problems, a method in which a recognition rate is improved by retraining a learning model using data collected from a server system and periodically reloading the retrained learning model into the recognizer is used. For example, an AI speaker recognizes individual voices and simultaneously stores the data in the server system. The speaker generates a new learning model by periodically relearning the stored data, the learning model is transmitted to the recognizer, and the recognizer is updated with the learning model, whereby the recognition rate is improved.

However, it is not easy for a device in an offline environment to periodically perform relearning using a server, and particularly, it is not easy for an embedded device to perform relearning because it does not have enough system resources, such as space for storing data or a learner.

Accordingly, the present invention intends to propose a system for automating partial training in order to implement a real-time object recognizer even in an offline environment or an embedded device.

### DOCUMENTS OF RELATED ART

(Patent Document 1) Korean Patent Application Publication No. 10-2019-0113451, published on Oct. 8, 2019.

### SUMMARY OF THE INVENTION

An object of the present invention is to provide a method and apparatus for enabling partial training using new data to be performed in real time in an embedded system having limited system resources.

Another object of the present invention is to continuously improve the learning intelligence of a learning model of AI even in an embedded system in an offline environment and to provide a method capable of implementing a recognizer optimized for an individual environment.

A method for partial training of AI according to an embodiment includes generating preprocessed input data by preprocessing input data; generating an inference result by inputting the preprocessed input data to the existing learning model of an inferrer; determining whether partial training is required based on the inference result; generating a partial-training dataset by combining first data, corresponding to the existing learning model, with second data, corresponding to the preprocessed input data, when it is determined that partial training is required; and performing partial training by inputting the partial-training dataset to a learner.

Here, generating the partial-training dataset may include receiving a partial-training mode from a user; and generating a partial-training settings file based on the partial-training mode. The partial-training mode may include an automatic mode or a lightweight data mode.

Here, generating the partial-training dataset may further include receiving partial-training data settings from the user; extracting the first data from an original dataset, corresponding to the existing learning model, based on the partial-training data settings; extracting the second data from the preprocessed input data based on the partial-training data settings; and generating the partial-training dataset by combining the first data with the second data.

Here, performing the partial training may include loading the existing learning model using a learning model loader; generating a partially trained learning model by training the existing learning model using the partial-training dataset; and changing the existing learning model to the partially trained learning model using a learning model transmitter.

Here, performing the partial training may include, when the partial training mode is the lightweight data mode, loading the lightweight model of the existing learning model using a learning model loader; generating a partially trained learning model by training the lightweight model using the partial-training dataset; and changing the existing learning model to the partially trained learning model using a learning model transmitter.

Here, extracting the first data may be configured to extract a number of pieces of representative data equal to a random sample number from each category of the original dataset, and the random sample number may be arbitrarily adjusted depending on a system or a training environment.

Here, performing the partial training may include performing, by the learner, partial training based on a partial-training execution signal; transmitting, by the learner, a partial-training completion signal to the inferrer when the partial training is completed; and changing, by the inferrer, the existing learning model to the partially trained existing learning model based on the partial-training completion signal. The partial-training completion signal may include the name and path of a file of the partially trained learning model.

Here, the learner may be a fine-tuning-based weight updater of a deep-learning framework.

Here, generating the partial-training dataset may further include, when the partial-training mode is the automatic mode, registering data to learn in an internal data structure in a training data repository; generating a label file required for partial training using the internal data structure; and generating the partial-training dataset by combining the data to learn with existing data, corresponding to the existing learning model, based on the generated label file.

Here, performing the partial training may include generating a settings file required for training using a deep-learning framework; generating a partially trained learning model in the deep-learning framework based on the settings file; and connecting the partially trained learning model to the inferrer.

An apparatus for partial training of AI according to an embodiment may include a processor for generating a partial-training dataset by combining first data, corresponding to an existing learning model, with second data, corresponding to preprocessed input data, and for generating a partially trained learning model by inputting the partial-training dataset to a learner; and memory for storing the partial-training dataset or the partially trained learning model.

Here, the processor may receive a partial-training mode from a user and generate a partial-training settings file based on the partial-training mode. The partial-training mode may include an automatic mode or a lightweight data mode.

Here, the processor may receive partial-training data settings from the user, extract the first data from an original dataset, corresponding to the existing learning model, based on the partial-training data settings, extract the second data from the preprocessed input data based on the partial-training data settings, and generate the partial-training dataset by combining the first data with the second data.

Here, the processor may load the existing learning model using a learning model loader, generate a partially trained learning model by partially training the existing learning model using the partial-training dataset, and change the existing learning model to the partially trained learning model using a learning model transmitter.

Here, when the partial-training mode is the lightweight data mode, the processor may load the lightweight model of the existing learning model using a learning model loader, generate a partially trained learning model by partially training the lightweight model using the partial-training dataset, and change the existing learning model to the partially trained learning model using a learning model transmitter.

Here, the processor may extract a number of pieces of representative data equal to a random sample number from each category of the original dataset, and the random sample number may be arbitrarily adjusted depending on a system or a training environment.

Here, the processor may perform operation such that the learner performs partial training based on a partial-training execution signal, such that the learner transmits a partial-training completion signal to an inferrer when the partial training is completed, and such that the inferrer changes the existing learning model to the partially trained existing learning model based on the partial-training completion signal. The partial-training completion signal may include the name and path of a file of the partially trained learning model.

Here, when the partial-training mode is the automatic mode, the processor may register data to learn in an internal data structure in a training data repository, generate a label file required for partial training using the internal data structure, and generate a dataset for partial training by combining the data to learn with existing data based on the generated label file.

Here, the processor may generate a settings file required for training using a deep-learning framework, generate a partially trained learning model in the deep-learning framework based on the generated settings file, and connect the partially trained learning model to an inferrer.

An apparatus for determining partial training of AI according to an embodiment may include a processor for generating preprocessed input data by preprocessing input data, generating an inference result by inputting the preprocessed input data to the existing learning model of an inferrer, determining whether partial learning is required based on the inference result, requesting a partial-training apparatus to perform partial training when it is determined that partial training is required, and updating the existing learning model of the inferrer by receiving a partially trained learning model from the partial-training apparatus; and memory for storing the existing learning model or the partially trained learning model.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a block diagram illustrating an example of a system for partial training of AI according to an embodiment;

FIG. 2 is a block diagram illustrating an example of the partial-training environment generation unit illustrated in FIG. 1;

FIG. 3 is a view illustrating an example of the user interface of the partial-training mode input unit illustrated in FIG. 2;

FIG. 4 is a view illustrating an example of the user interface of the partial-training data setting input unit illustrated in FIG. 2;

FIG. 5 is a block diagram illustrating an example of the partial-training execution unit illustrated in FIG. 1;

FIG. 6 is a view illustrating that an inferrer is immediately updated with a partially trained learning model, which is trained using a method for partial training of AI according to an embodiment;

FIG. 7 is a view illustrating a flowchart of operation in a partial-training apparatus when a partial-training mode is an automatic mode;

FIG. 8 is a view illustrating an example of a procedure in which a partial-training dataset is generated in a partial-training data generation unit;

FIG. 9 is a view illustrating a flowchart of a method for partial training of AI according to an embodiment;

FIG. 10 is a view illustrating a computer system configuration according to an embodiment; and

FIG. 11 is block diagram illustrating an example of an apparatus for generating the partial training dataset according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

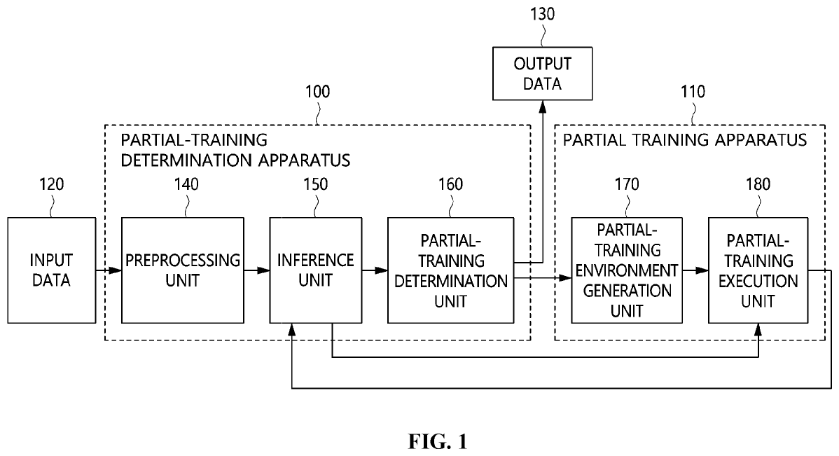

Hereinafter, a method for partial training of AI and an apparatus therefor according to an embodiment will be described in detail with reference to FIGS. 1 to 10.

FIG. 1 is a block diagram illustrating an example of a system for partial training of AI according to an embodiment.

Referring to FIG. 1, in order to implement a method for partial training of AI, the system for partial training of AI may include a partial-training determination apparatus 100 and a partial-training apparatus 110. The system for partial training of AI is a training system of AI for recognizing an object or voice in real time, the system being applicable to an embedded device having limited system resources.

The partial-training determination apparatus 100 may receive input data 120 for inference as input and determine whether to perform partial training based on the inference result. When it determines that partial training is required, the partial-training determination apparatus 100 requests the partial-training apparatus 110 to perform partial training and updates the existing learning model of an inferrer by receiving the partially trained learning model from the partial-training apparatus 110. When it determines that partial training is not required, the partial-training determination apparatus 100 outputs the inference result as output data 130.

The partial-training determination apparatus 100 may include a preprocessing unit 140, an inference unit 150, and a partial-training determination unit 160. The preprocessing unit 140 generates preprocessed input data by preprocessing the input data 120. The inference unit 150 inputs the preprocessed input data to the existing learning model of the inferrer, thereby generating an inference result. The partial-training determination unit 160 determines whether partial training is required based on the inference result.

The preprocessing unit 140 generates preprocessed input data by preprocessing input data. Here, ‘preprocessing’ indicates processing data in order to improve the accuracy of inference.

Because the inference unit 150 (or the inferrer) includes the existing learning model, which is a model that has been trained in advance, the input data processed by the preprocessing unit 140 is input to the existing learning model, whereby an inference result is generated. Generally, the inference result is provided as a probability value.

The partial-training determination unit 160 performs the operation of determining whether partial training is required based on the inference result. The partial-training determination unit 160 compares the inference result with the result desired by a user, thereby determining whether partial training is required. When the inference result is equal to the result desired by the user, it is determined that partial training is not required, and the inference result is output as the output data 130. When the inference result is different from the result desired by the user, it is determined that partial training is required, and partial training is requested by delivering a partial-training execution signal to the partial-training apparatus. The user may input the result desired by the user using a separate user interface, or may perform the operation of determining whether partial training is required by directly comparing the results himself/herself.

As described above, when the partial-training determination unit 160 determines that partial training is required, that is, when the partial-training apparatus 110 receives a partial-training execution signal from the partial-training determination unit 160, the partial-training apparatus 110 may generate a partial-training dataset and perform the partial-training operation using the dataset.

The partial-training apparatus 110 may include a partial-training environment generation unit 170 and a partial-training execution unit 180.

The partial-training environment generation unit 170 receives settings for partial training from a user through a user interface and generates a settings file and a partial-training dataset required for partial training based on the settings. The partial-training execution unit 180 performs training in a learner based on the settings file and the partial-training dataset generated by the partial-training environment generation unit 170.

The partial-training environment generation unit 170 may receive a partial-training mode from a user and perform the operation of generating a partial-training settings file based on the partial-training mode. The partial-training mode may include an automatic mode or a lightweight data mode. When the automatic mode is selected, partial training is continuously performed until the result desired by the user is obtained. When the automatic mode is not selected as the partial-training mode, the partial-training mode is set to a manual mode, and in the manual mode, whenever partial training is performed, the user may check the inference result and determine whether to perform partial training. If the lightweight mode is selected, when partial training is performed by taking the existing learning model, the lightweight learning model of the existing learning model is used. The lightweight data mode may be usefully used when real-time operation is more important than the accuracy of the result in a terminal having limited system resources.

Also, the partial-training environment generation unit 170 may receive partial-training data settings from a user, and may perform the operation of generating a partial-training dataset by combining first data, corresponding to the existing learning model, with second data, corresponding to the preprocessed input data.

Here, the first data may be generated by extracting a part of the original dataset corresponding to the existing learning model. Here, the second data may be generated by extracting some of the preprocessed input data.

Because the partial-training dataset generated in this way is much smaller than the original dataset, partial training becomes possible even in a system in which system resources are not abundant.

Also, the operation of extracting the first data is configured to extract a number of pieces of representative data equal to a random sample number from each category of the original dataset, and the random sample number may be arbitrarily adjusted depending on the system or the training environment. Accordingly, an overfitting problem, in which learning weights are biased when a partial-training dataset formed of only new data is generated and used, may be solved.

The partial-training mode and the partial-training data settings may be input through user interfaces. The user interface for the partial-training mode may include automatic mode settings, lightweight data mode settings, and partial-training path settings. Here, the partial-training path settings may include the location of a deep-learning framework required for partial training, the location of data, the location of a learning model, the location of a settings file required for training, and the location at which partial training is executed. Also, the user interface for the partial-training data settings may include a data repository, a training data repository, a register button, a delete button, and a partial-training execution button.

The partial-training execution unit 180 may perform the operation of generating a partially trained learning model by partially training the existing learning model using the partial-training dataset generated by the partial-training environment generation unit 170. In order to perform this operation, the partial-training execution unit 180 takes the existing learning model using a learning model loader. The partial-training execution unit 180 partially trains the existing learning model using the partial-training dataset, thereby generating a partially trained learning model. Here, the partial-training settings file generated by the partial-training environment generation unit 170 may be used. Then, the partial-training execution unit 180 changes the existing learning model to the partially trained learning model using a learning model transmitter.

When the partial-training mode is a lightweight data mode, the partial-training execution unit 180 may use the lightweight model of the existing learning model in place of the existing learning model. That is, the lightweight model of the existing learning model is acquired using the learning model loader, and a partially trained learning model is generated by training the lightweight model using the partial-training dataset. Then, using the learning model transmitter, the existing learning model is updated to the partially trained learning model.

Here, in order to learn the partial-training dataset, a deep-learning framework such as Caffe or TensorFlow may be generally used. Also, the partial-training dataset may be learned using the fine-tuning-based weight updater of the deep-learning framework. First, the existing learning model is loaded through the IPC-based learning model loader, and a partially trained learning model is generated using the weight updater. Here, the fine-tuning-based weight updater may use functions provided by the deep-learning framework, or a self-developed weight updater may alternatively be used. The partially trained learning model replaces the learning model used in the inferrer through the IPC-based learning model transmitter.

The inferrer may not recognize newly input data at first, or may exhibit a low recognition rate, but when partial training is performed once or more, the recognition rate is increased, and ultimately, a recognition rate desired by a user may be realized. Here, in order to enable training even in a device in which system resources are not abundant, a pre-training method provided by the deep-learning framework may be used.

When the automatic mode is selected as the partial-training mode, the partial-training apparatus may operate as follows. First, the partial-training environment generation unit 170 may register the data to learn in the internal data structure in the training data repository, and may generate a label file required for partial training using the internal data structure. Then, based on the generated label file, the data to learn and the existing data corresponding to the existing learning model are combined, whereby a partial-training dataset may be generated.

Here, the partial-training execution unit 180 may generate a settings file required for training using the deep-learning framework. Based on the settings file, a partially trained learning model trained in the deep-learning framework is generated, and the operation of connecting the partially trained learning model to the inferrer of the inference unit 150 may be performed.

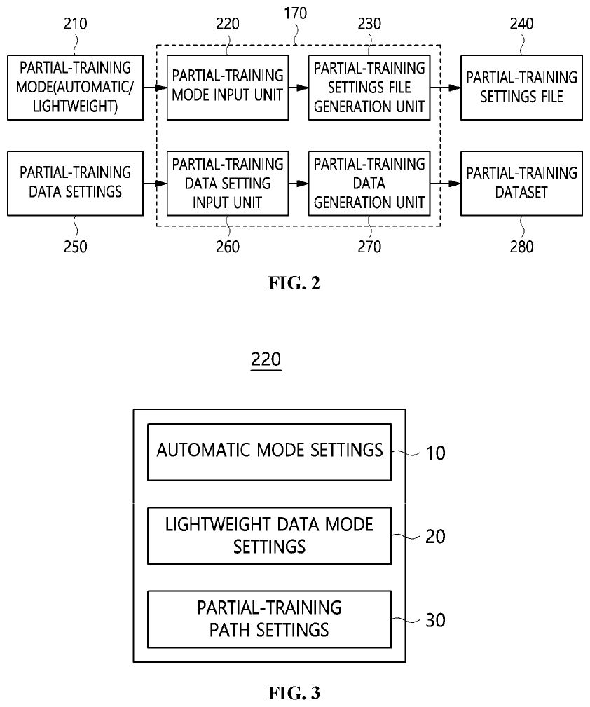

FIG. 2 is a block diagram illustrating an example of the partial-training environment generation unit 170 illustrated in FIG. 1.

Referring to FIG. 2, the partial-training environment generation unit 170 receives a partial-training mode 210 and partial-training data settings 250 as input. The partial-training environment generation unit 170 generates a partial-training settings file 240 based on the partial-training mode and outputs the same, and generates a partial-training dataset 280 based on the partial-training data settings and outputs the same.

Also, the partial-training environment generation unit 170 may include a partial-training mode input unit 220, a partial-training settings file generation unit 230, a partial-training data setting input unit 260, and a partial-training data generation unit 270.

The partial-training mode input unit 220 may receive information about selection of a partial-training mode 210 from a user, and the partial-training settings file generation unit 230 may perform the operation of generating a partial-training settings file 240 based on the partial-training mode 210. The partial-training mode 210 may include an automatic mode or a lightweight data mode. When the automatic mode is selected, partial training is continuously performed until the result desired by the user is acquired. When the automatic mode is not selected as the partial-training mode, the partial-training mode is set to a manual mode, and in the manual mode, whenever partial training is performed, the user may check the inference result and determine whether to perform partial training. If the lightweight data mode is selected, when partial training is performed by loading the existing learning model, the lightweight learning model of the existing learning model is used. The lightweight data mode may be usefully used when real-time operation is more important than the accuracy of the result in a terminal having limited system resources.

Also, the partial-training data setting input unit 260 may receive partial-training data settings from the user, and may perform the operation of generating a partial-training dataset 280 by combining first data, corresponding to the existing learning model of the inference unit (or inferrer), with second data, corresponding to the input data preprocessed by the preprocessing unit.

Here, the first data may be generated by extracting a part of the original dataset corresponding to the existing learning model. Here, the second data may be generated by extracting some of the preprocessed input data.

Because the partial-training dataset generated in this way is much smaller than the original dataset, partial training becomes possible even in a system in which system resources are not abundant.

Also, the operation of extracting the first data is configured to extract a number of pieces of representative data equal to a random sample number from each category of the original dataset, and the random sample number may be arbitrarily adjusted depending on the system or the training environment. Accordingly, an overfitting problem, in which learning weights are biased when a partial-training dataset formed of only new data is generated and used, may be solved.

The partial-training mode input unit 220 and the partial-training data setting input unit 260 may receive input through user interfaces. Here, the user interface of the partial-training mode input unit 220 may include automatic mode settings, lightweight data mode settings, and partial-training path settings. Here, the partial-training path settings may include the location of a deep-learning framework required for partial training, the location of data, the location of a learning model, the location of a settings file required for training, and the location at which partial training is executed. Also, the user interface of the partial-training data setting input unit 260 may include a data repository, a training data repository, a register button, a delete button, and a partial-training execution button.

FIG. 3 is a view illustrating an example of the user interface of the partial-training mode input unit 220 illustrated in FIG. 2.

Referring to FIG. 3, the user interface of the partial-training mode input unit 220 may include three settings tabs for automatic mode settings 10, lightweight data mode settings 20, and partial-training path settings 30.

When a user touches the settings tab for the automatic mode settings 10, partial training is performed in the automatic mode, and partial training is continuously performed until the result desired by the user is acquired. Here, it is assumed that the result desired by the user has already been input. If the settings tab for the automatic mode settings 10 is not touched, the settings are maintained at basic settings, in which case the mode is a manual mode. In the manual mode, whenever partial training is performed, the user may check the inference result and determine whether to perform partial training. The selection of whether to perform partial training may be input through another user interface.

If the user touches the settings tab for the lightweight data mode settings 20, when the existing learning model is loaded in order to perform partial training, the lightweight learning model of the existing learning model is loaded and used. This lightweight data mode may be usefully used when real-time operation is more important than the accuracy of the result in a terminal having limited system resources.

When the user touches the settings tab for the partial-training path settings 30, the location of a deep-learning framework required for partial training, the location of data, the location of a learning model, the location of a settings file required for training, the location at which partial training is executed, and the like may be set.

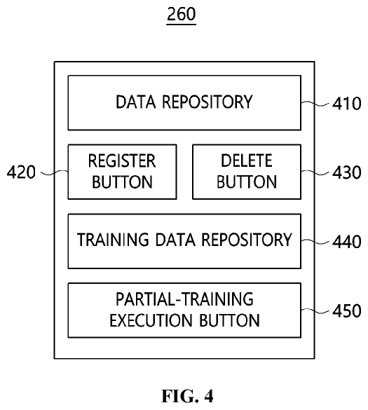

FIG. 4 is a view illustrating an example of the user interface of the partial-training data setting input unit 260 illustrated in FIG. 2.

Referring to FIG. 4, the user interface of the partial-training data setting input unit 260 may include two repositories and three buttons. That is, two repositories, including a data repository 410 and a training data repository 440, and three buttons, including a register button 420, a delete button 430, and a partial-training execution button 450, may be included therein.

The data repository 410 is a repository in which data required for training is stored, like a gallery folder in a smart device. The data stored in the data repository 410 is data that is already preprocessed by a preprocessor.

The training data repository 440 is a repository in which data, selected by a user from the data repository 410 in order to perform partial training, is stored after being labeled.

The user may transfer some of the data in the data repository 410 to the training data repository 440 using the register button 420. The user may delete unnecessary data from the training data repository 440 using the delete button 430. The user may internally perform partial training using the data stored in the training data repository by selecting the partial-training execution button 450. After partial training is performed, a file of the partially trained learning model may be generated at the location of a learning model, the location being saved in the partial-training path settings.

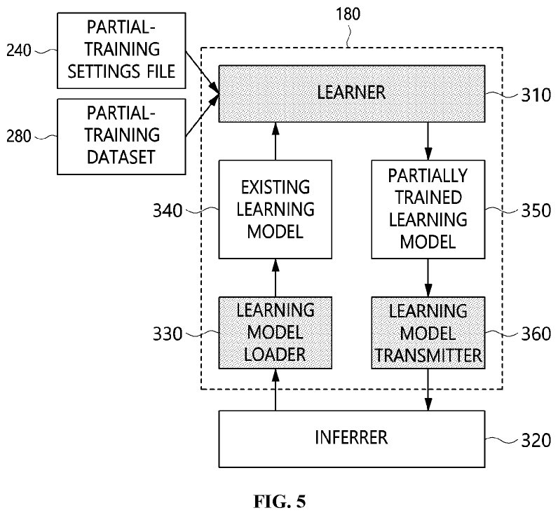

FIG. 5 is a block diagram illustrating an example of the partial-training execution unit 180 illustrated in FIG. 1.

Referring to FIG. 5, the partial-training execution unit 180 receives the partial-training settings file 240 and the partial-training dataset 280 as input and trains the existing learning model 340 using a learner 310, thereby generating a partially trained learning model 350. The partial-training execution unit 180 may include the learner 310, a learning model loader 330, the existing learning model 340, the partially trained learning model 350, and a learning model transmitter 360.

The learning model loader 330 may take the existing learning model 340 from the inferrer 320. The learner 310 may train the existing learning model 340 by receiving the partial-training settings file 240 and the partial-training dataset 280 from the partial-training environment generation unit. The learning model transmitter 360 transmits the partially trained learning model 350 generated by the learner 310 to the inferrer, thereby changing the existing learning model of the inferrer.

When the lightweight data mode is selected as the partial-training mode, the learner 310 may use the lightweight model of the existing learning model, rather than the existing learning model. That is, the learning model loader 330 takes the lightweight model of the existing learning model from the inferrer 320, and the learner 310 trains the lightweight model, thereby generating a partially trained learning model. Then, the learning model transmitter 360 transmits the partially trained learning model to the inferrer, thereby changing the existing learning model of the inferrer.

Here, the learning model loader 330 may be a learning model loader based on Inter-Processor Communication (IPC). The learning model transmitter 360 may also be a learning model transmitter based on IPC.

Also, the learner 310 may generally use a deep-learning framework such as Caffe or TensorFlow. Also, the partial-training dataset may be learned using the fine-tuning-based weight updater of the deep-learning framework. First, the existing learning model is loaded through the learning model loader based on IPC, and a partially trained learning model is generated using the weight updater. Here, the fine-tuning-based weight updater may use functions provided by the deep-learning framework, or a self-developed weight updater may alternatively be used.

The inferrer 320 may not recognize newly input data at first, or may exhibit a low recognition rate, but when partial training is performed at least once, the recognition rate is increased, and ultimately, the recognition rate desired by a user may be realized. Here, in order to enable training even in a device in which system resources are not abundant, a pre-training method provided by the deep-learning framework may be used.

When an automatic mode is selected as the partial-training mode, the partial-training dataset 280 and the partial-training settings file 240 are not input. Instead, the learner 310 may generate a settings file required for training using the deep-learning framework, and may generate a partially trained learning model trained in the deep-learning framework based on the settings file. Then, the learner 310 performs the operation of connecting the partially trained learning model to the inferrer 320.

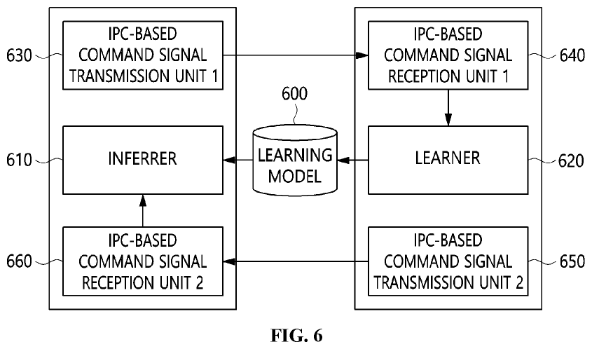

FIG. 6 is a view illustrating that an inferrer is immediately updated with a partially trained learning model, which is trained using a method for partial training of AI according to an embodiment.

Referring to FIG. 6, an IPC-based command signal transmission unit 1 630 transmits a command signal for partial training to a partial-training execution unit when configuration of partial-training settings is completed in the partial-training environment generation unit. Upon receiving the command signal, an IPC-based command signal reception unit 1 640 requests the learner 620 to generate a partially trained learning model 600. When generation of the partially trained learning model is completed in the learner 620, an IPC-based command signal transmission unit 2 650 transmits a partial-training completion signal. Upon receiving the completion signal, an IPC-based command signal reception unit 2 660 sends an update request for changing the learning model to the inferrer 610. In response to the update request, the inferrer 610 deletes the existing learning model and adds the partially trained learning model 600. Then, when the inferrer 610 performs inference using the updated learning model, accuracy may be improved compared to the previous recognition rate.

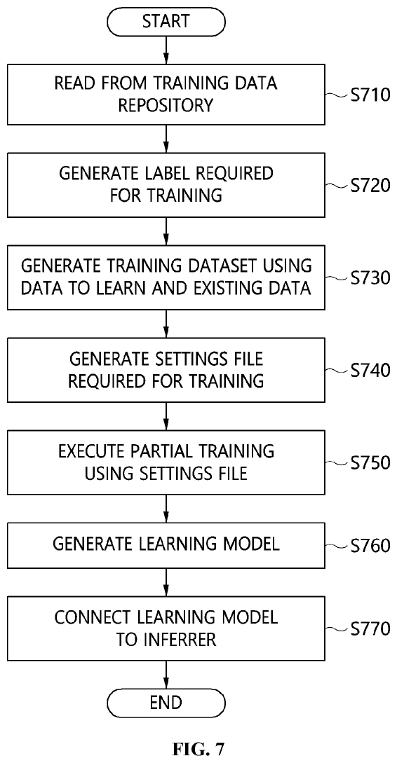

FIG. 7 is a view illustrating a flowchart of operation in a partial-training apparatus when the partial training mode is an automatic mode.

Referring to FIG. 7, first, the data to learn is registered in an internal data structure by reading the same from a training data repository at step S710. Using the internal data structure, a label file required for partial training is generated at step S720. Based on the generated label file, the data to learn and the existing data are combined, whereby a dataset for partial training is generated at step S730.

Then, using a deep-learning framework, a settings file required for training is generated at step S740. Based on the settings file, a partially trained learning model is generated in the deep-learning framework at step S750. Execution of partial training is performed in the deep-learning framework. When partial training is completed, a learning model is generated, and the generated learning model that is partially trained is immediately connected to the inferrer at step S770.

The above-described partial-training operation in the automatic mode is repeated until the inference result desired by the user is obtained.

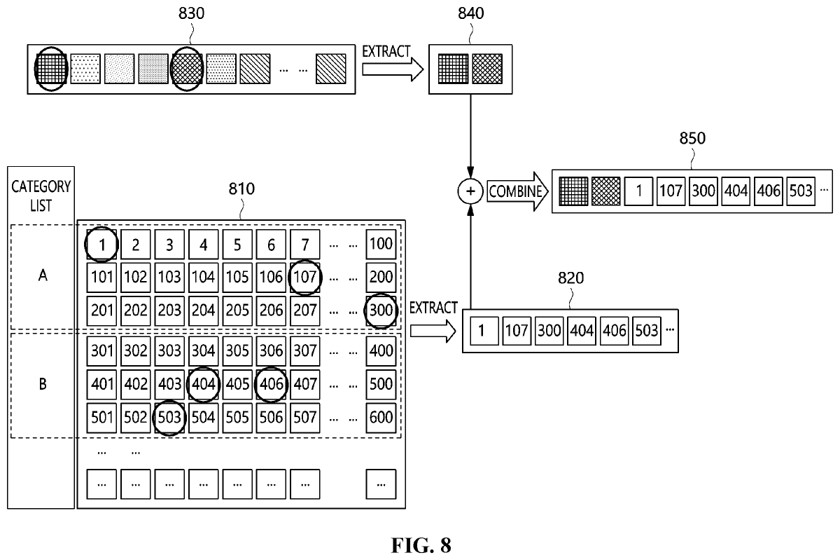

FIG. 8 is a view illustrating an example of a procedure in which a partial-training dataset is generated in a partial-training data generation unit.

Referring to FIG. 8, the partial-training data generation unit receives partial-training data settings from a user. Based on the partial-training data settings, first data 820 is extracted from the original dataset 810, corresponding to the existing learning model. Then, the partial-training data generation unit extracts second data 840 from the preprocessed input data 830 based on the partial-training data settings. The operation of extracting the first data and the operation of extracting the second data may be performed at the same time or at different times. Also, the partial-training data generation unit generates a partial-training dataset 850 by combining (mixing) the first data 820 with the second data 840.

The reason why the partial-training dataset is required is for enabling training even in a system in which resources are not abundant. The partial-training dataset may be generated only when the user requires the same, rather than always being generated.

In response to user requirements for partial training for new data, first data is generated by extracting a number of pieces of representative data equal to a random sample number from each category of the original dataset 810 in order to efficiently incorporate the category list of the existing learning model. The random sample number may be arbitrarily adjusted by a user depending on the system or the training environment. This is because learning weights can be biased when training data is generated by including only new data. That is, this solves an overfitting problem.

FIG. 8 shows an example in which the random sample number is set to 3 for convenience of description. That is, three pieces of data, namely pieces number 1, 107 and 300, are extracted from among 300 pieces of data in category A, and three pieces of data, namely pieces number 404, 406 and 503, are extracted from among 300 pieces of data in category B. Accordingly, the first data 820 generated in this way includes pieces number 1, 107, 300, 404, 406 and 503.

Also, second data 840 is generated by extracting data selected by the user from the preprocessed input data 830, which is generated by preprocessing the newly input data. In FIG. 8, an example in which the first piece of data and the fifth piece of data are selected is illustrated.

Then, a partial-training dataset 850 is generated by combining the first data and the second data. Because the partial-training dataset includes a much smaller amount of data than the original dataset, it is advantageous in that training is possible even in a system in which resources are not abundant. Through training using the partial-training dataset, a partially trained learning model is generated, and the existing learning model of the inferrer is updated to the partially trained learning model by changing the existing learning model to the partially trained learning model.

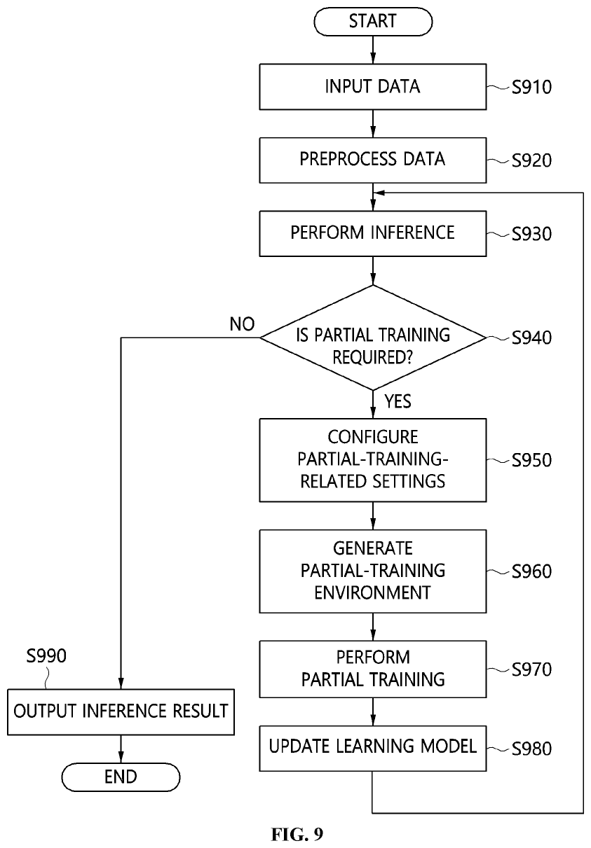

FIG. 9 is a view illustrating a flowchart of a method for partial training of AI according to an embodiment.

Referring to FIG. 9, first, data for inference is input to an apparatus for determining partial training of AI at step S910. The apparatus for determining partial training preprocesses the input data and thereby generates preprocessed input data at step S920 in order to improve the accuracy of inference.

Then, the preprocessed input data is input to the existing learning model of the inferrer, whereby an inference result is generated at step S930. That is, because the existing learning model, which is a model that has been trained in advance, is loaded into the inferrer, an inference result is generated by inputting the preprocessed input data to the existing learning model. The inference result is generally provided as a probability value.

Based on the inference result, whether partial training is required is determined at step S940. That is, the inference result is compared with the result desired by a user.

When the inference result is different from the result desired by the user, it is determined that partial training is required, and a partial-training execution signal is transmitted to a partial-training apparatus, whereby partial training is requested. The operation in which the user inputs the desired result or the operation of determining whether to perform partial training by comparing the results may be performed by the user through a separate user interface.

When it is determined that partial training is required (Yes at step S940), operation in the partial-training apparatus is performed.

The partial-training apparatus receives settings related to partial training through a user interface at step S950. That is, a partial-training mode and partial-training data settings may be received from the user. The partial-training mode may include an automatic mode, a lightweight data mode, or partial-training path settings.

Then, the partial-training apparatus generates a partial-training settings file and a partial-training dataset at step S960 based on the partial-training-related settings. That is, the partial-training settings file is generated based on the partial-training mode, and the partial-training dataset is generated based on the partial-training data settings. Here, the partial-training dataset may be generated by combining first data, corresponding to the existing learning model, with second data, corresponding to the preprocessed input data.

Then, the partial-training apparatus performs partial training based on the partial-training settings file and the partial-training dataset at step S970. First, the partial-training apparatus takes the existing learning model using a learning model loader. Then, the existing learning model is partially trained using the partial-training settings file and the partial-training dataset, whereby a partially trained learning model is generated. Then, the existing learning model is changed to the partially trained learning model using a learning model transmitter.

When the partial-training mode is a lightweight data mode, the partial-training apparatus takes the lightweight model of the existing learning model using the learning model loader. Then, the lightweight model is trained using the partial-training settings file and the partial-training dataset, whereby a partially trained learning model is generated. Then, the existing learning model is changed to the partially trained learning model using the learning model transmitter. Accordingly, partial training may be performed even in a terminal having limited system resources.

As described above, when the partially trained learning model is generated in such a way that the partial-training apparatus performs partial training, the existing learning model is updated to the partially trained learning model at step S980 by changing the existing learning model to the partially trained learning model. Then, the process goes back to the inference step (S930) such that inference is performed, and the step (S940) of determining whether partial training is required based on the inference result is performed again. This partial-training process is repeated until the inference result desired by the user is obtained.

When the inference result desired by the user is obtained, it is determined that partial training is no longer required (No at step S940), and the inference result is output as output data at step S990.

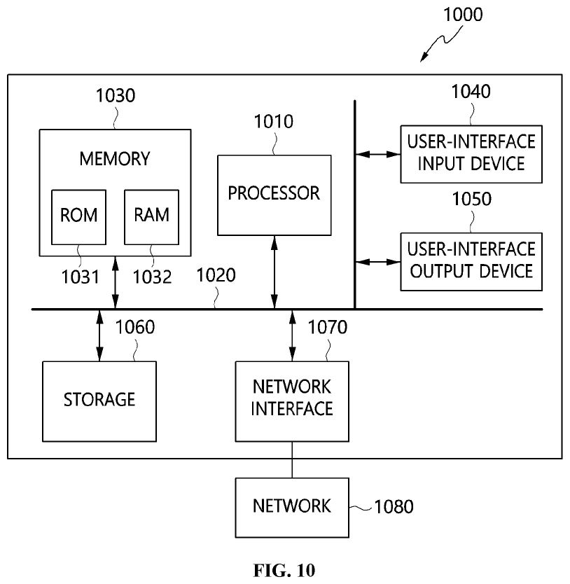

FIG. 10 is a view illustrating a computer system configuration according to an embodiment.

The apparatus for partial training of AI or the apparatus for determining partial training of AI according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

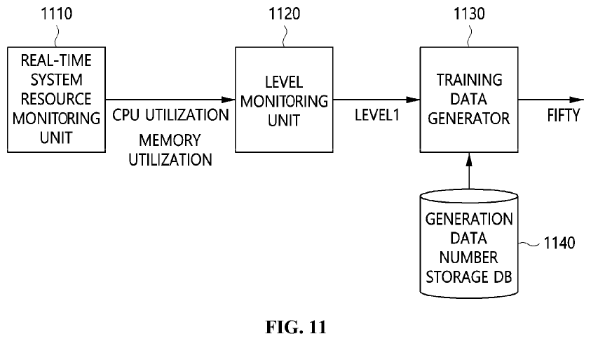

FIG. 11 is block diagram illustrating an example of an apparatus for generating the partial training dataset according to an embodiment.

Referring to FIG. 11, the apparatus for generating the partial training dataset according to the embodiment includes the real-time system resource monitoring unit 1110, the level monitoring unit 1120, the training data generator 1130 and the generation data number storage database 1140.

The real-time system resource monitoring unit 1110 measures the system resources of the systems such as embedded systems in real time. In this case, the system resources may be the CPU utilization and/or the memory utilization.

The level monitoring unit 1120 selects one level among a plurality of predetermined levels based on the system resource(s) which is(are) measured by the real-time system resource monitoring unit 1110. For example, the level monitoring unit 1120 may select one among level1˜level10. For example, the higher the CPU utilization and/or the memory utilization, the lower the level may be selected as it is considered that there are not enough system resources available for the partial learning.

The level selected by the level monitoring unit 1120 in the example of FIG. 11 may be level1.

The training data generator 1130 generates the training data according to the decided level by the level monitoring unit 1120. In this case, the training data generator 1130 may read the number of the training data assigned to the corresponding level from the generation data number storage database 1140 and then generate the training data of the read number. In this case, the number of data corresponding to each level may be stored in the generation data number storage database 1140. For example, the lower the level, the smaller the number of data may be stored.

In the example illustrated in FIG. 11, the number of training data generated by the training data generator 1130 may be 50, which is the number allocated to level1.

In this case, the number of data for each level may be appropriately determined according to system conditions. For example, the number of data for each level may be determined using one of an automatic determination mode using artificial intelligence (AI) technology or a manual determination mode in which a user designates an arbitrary value to a specific level.

The apparatus for generating the partial training dataset illustrated in FIG. 11 generates training data by using dynamic information of system resources, so that training data suitable for a situation can be generated in systems such as the embedded systems.

The generation data number storage database 1140 may store not only the number of training data for each level, but also the extraction ratio of the first data, the extraction ratio of the second data, and/or the combining (mixing) ratio of the first data and the second data described with reference to FIG. 8. That is, the extraction ratio of the first data, the extraction ratio of the second data, and the combining (mixing) ratio of the first data and the second data may vary according to the system resource situation.

According to the above-described embodiment, a method and apparatus for enabling partial training using new data to be performed in real time in an embedded system having limited system resources may be provided.

Also, the present invention may steadily improve the learning intelligence of a learning model of AI even in an embedded system in an offline environment, and may provide a method capable of implementing a recognizer optimized for an individual environment.

The present invention may provide a method and apparatus for enabling partial training using new data to be performed in real time in an embedded system having limited system resources.

Also, the present invention may steadily improve the learning intelligence of a learning model of AI even in an embedded system in an offline environment, and may provide a method capable of implementing a recognizer optimized for an individual environment.

Although the embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. A method for partial training of Artificial Intelligence (AI), comprising:
generating preprocessed input data by preprocessing input data;
generating an inference result by inputting the preprocessed input data to an existing learning model of an inferrer;
determining whether partial training is required based on the inference result;
generating a partial-training dataset by combining first data, corresponding to the existing learning model, with second data, corresponding to the preprocessed input data, when it is determined that partial training is required; and
performing partial training by inputting the partial-training dataset to a learner.

2. The method of claim 1, wherein generating the partial-training dataset comprises:
receiving a partial-training mode from a user; and
generating a partial-training settings file based on the partial-training mode,
wherein the partial-training mode includes an automatic mode or a lightweight data mode.

3. The method of claim 2, wherein generating the partial-training dataset further comprises:
receiving partial-training data settings from the user;
extracting the first data from an original dataset, corresponding to the existing learning model, based on the partial-training data settings;
extracting the second data from the preprocessed input data based on the partial-training data settings; and
generating the partial-training dataset by combining the first data with the second data.

4. The method of claim 3, wherein performing the partial training comprises:
loading the existing learning model using a learning model loader;
generating a partially trained learning model by training the existing learning model using the partial-training dataset; and
changing the existing learning model to the partially trained learning model using a learning model transmitter.

5. The method of claim 3, wherein performing the partial training comprises:
when the partial-training mode is the lightweight data mode,
loading a lightweight model of the existing learning model using a learning model loader;
generating a partially trained learning model by training the lightweight model using the partial-training dataset; and
changing the existing learning model to the partially trained learning model using a learning model transmitter.

6. The method of claim 3, wherein extracting the first data is configured to extract a number of pieces of representative data equal to a random sample number from each category of the original dataset,
wherein the random sample number is capable of being arbitrarily adjusted depending on a system or a training environment.

7. The method of claim 1, wherein performing the partial training comprises:
performing, by the learner, partial training based on a partial-training execution signal;
transmitting, by the learner, a partial-training completion signal to the inferrer when the partial training is completed; and
changing, by the inferrer, the existing learning model to the partially trained existing learning model based on the partial-training completion signal,
wherein the partial-training completion signal includes a name and a path of a file of the partially trained learning model.

8. The method of claim 7, wherein the learner is a fine-tuning-based weight updater of a deep-learning framework.

9. The method of claim 2, wherein generating the partial-training dataset further comprises:
when the partial-training mode is the automatic mode,
registering data to learn in an internal data structure in a training data repository;
generating a label file required for partial training using the internal data structure; and
generating the partial-training dataset by combining the data to learn with existing data, corresponding to the existing learning model, based on the generated label file.

10. The method of claim 9, wherein performing the partial training comprises:
generating a settings file required for training using a deep-learning framework;
generating a partially trained learning model in the deep-learning framework based on the settings file; and
connecting the partially trained learning model to the inferrer.

11. An apparatus for partial training of AI, comprising:
a processor for generating a partial-training dataset by combining first data, corresponding to an existing learning model, with second data, corresponding to preprocessed input data, and for generating a partially trained learning model by inputting the partial-training dataset to a learner; and
memory for storing the partial-training dataset or the partially trained learning model.

12. The apparatus of claim 11, wherein the processor receives a partial-training mode from a user and generates a partial-training settings file based on the partial-training mode,
wherein the partial-training mode includes an automatic mode or a lightweight data mode.

13. The apparatus of claim 12, wherein the processor receives partial-training data settings from the user, extracts the first data from an original dataset, corresponding to the existing learning model, based on the partial-training data settings, extracts the second data from the preprocessed input data based on the partial-training data settings, and generates the partial-training dataset by combining the first data with the second data.

14. The apparatus of claim 13, wherein the processor loads the existing learning model using a learning model loader, generates a partially trained learning model by partially training the existing learning model using the partial-training dataset, and changes the existing learning model to the partially trained learning model using a learning model transmitter.

15. The apparatus of claim 13, wherein, when the partial training mode is the lightweight data mode, the processor loads a lightweight model of the existing learning model using a learning model loader, generates a partially trained learning model by partially training the lightweight model using the partial-training dataset, and changes the existing learning model to the partially trained learning model using a learning model transmitter.

16. The apparatus of claim 13, wherein the processor extracts a number of pieces of representative data equal to a random sample number from each category of the original dataset,
wherein the random sample number is capable of being arbitrarily adjusted depending on a system or a training environment.

17. The apparatus of claim 11, wherein the processor performs operation such that the learner performs partial training based on a partial-training execution signal, such that the learner transmits a partial-training completion signal to an inferrer when the partial training is completed, and such that the inferrer changes the existing learning model to the partially trained existing learning model based on the partial-training completion signal,
wherein the partial-training completion signal includes a name and a path of a file of the partially trained learning model.

18. The apparatus of claim 12, wherein, when the partial-training mode is the automatic mode, the processor registers data to learn in an internal data structure in a training data repository, generates a label file required for partial training using the internal data structure, and generates a dataset for partial training by combining the data to learn with existing data based on the generated label file.

19. The apparatus of claim 18, wherein the processor generates a settings file required for training using a deep-learning framework, generates a partially trained learning model in the deep-learning framework based on the generated settings file, and connects the partially trained learning model to an inferrer.

20. An apparatus for determining partial training of AI, comprising:
a processor for generating preprocessed input data by preprocessing input data, generating an inference result by inputting the preprocessed input data to an existing learning model of an inferrer, determining whether partial learning is required based on the inference result, requesting a partial-training apparatus to perform partial training when it is determined that partial training is required, and updating the existing learning model of the inferrer by receiving a partially trained learning model from the partial-training apparatus; and
memory for storing the existing learning model or the partially trained learning model.
